(19) United States
(12) Patent Application Publication
(10) Pub. No.: US 2022/0098090 A1
(43) Pub. Date: Mar. 31, 2022

(54) CRYSTALLIZED GLASS

(71) Applicant: AGC Inc., Tokyo (JP)

(72) Inventors: Hiroki HIRAO, Tokyo (JP); Shusaku AKIBA, Tokyo (JP)

(73) Assignee: AGC Inc., Tokyo (JP)

(21) Appl. No.: 17/365,268

(22) Filed: Jul. 1, 2021

(30) Foreign Application Priority Data
Sep. 25, 2020 (JP) 2020-161095

(51) Int. Cl. C03C 10/00; C03B 32/02; C03C 21/00

(52) U.S. Cl. CPC C03C 10/0027; C03B 32/02; C03C 2204/00; C03C 10/0054; C03C 21/002

(57) ABSTRACT

The present invention relates to a crystallized glass having a visible-light transmittance of 88% or more in terms of a thickness of 0.7 mm, having a volume fraction of a crystalline phase of 30% or more, and including SnO₂, in which the number of bubbles having a major-axis length of 10 μm-50 μm is 3 or less per 10 cm³.

### TECHNICAL FIELD

The present invention relates to a crystallized glass.

### BACKGROUND ART

A crystallized glass is a material obtained by reheating a glass to precipitate crystals in the glass. Crystallized glasses have been known for long and used as tableware, dental materials, a top plate of an IH cooking heater, etc.

Nowadays, chemically strengthened glasses are used as protective covers of displays such as electronic devices represented by smartphones, and crystallized glasses capable of being chemically strengthened are highly expected to attain greater strength.

A chemically strengthened glass is obtained, for example, by bringing a glass into contact with a molten salt including alkali metal ions to cause ion exchange between alkali metal ions contained in the glass and alkali metal ions present in the molten salt, thereby forming a compressive-stress layer in the glass surfaces.

For example, Patent Document 1 describes a transparent crystallized glass. However, a composition for the transparent crystallized glass capable of being chemically strengthened is limited. Further, for producing a glass containing few inclusions such as bubbles and having high quality that renders the glass suitable for use as the cover glass of displays by such a composition, it is necessary to use a high level of refining technique including the selection of a refining agent and regulation of the amount thereof.

Patent Document 2 discloses a crystallized glass having a low crystallinity (volume fraction of crystalline phase).

For using a crystallized glass as a protective cover, it is important to enhance mechanical strength of the crystallized glass. From this standpoint, it is preferred to increase the volume fraction of crystalline phase. However, increase of the volume fraction of crystalline phase is prone to result in an appearance failure.

### CITATION LIST

### Patent Literature

Patent Document 1: International Publication WO 2011/152337

Patent Document 2: Japanese Patent No. 6643243

### SUMMARY OF THE INVENTION

### Technical Problem

An object of the present invention is to provide a crystallized glass having few appearance failures and excellent visible-light transmittance.

### Solution to the Problem

A crystallized glass according to one aspect of the present invention is a crystallized glass having a visible-light transmittance of 88% or more in terms of a thickness of 0.7 mm,

having a volume fraction of a crystalline phase of 30% or more, and

including SnO₂,

in which the number of bubbles having a major-axis length of 10 μm-50 μm is 3 or less per 10 cm³.

It is preferable that this crystallized glass includes, in terms of mol % on an oxide basis, 40-80% of SiO₂, 2-20% of Al₂O₃, 10-40% of Li₂O, and 0.1-3% of SnO₂.

It is preferable that this crystallized glass includes LAS crystals.

A crystallized glass according to another aspect of the present invention is a crystallized glass including crystals of at least one kind selected from the group consisting of β-spodumene crystals, petalite crystals, and eucryptite crystals, and

having a visible-light transmittance of 88% or more in terms of a thickness of 0.7 mm,

in which the number of bubbles having a major-axis length of 10 μm-50 μm is 3 or less per 10 cm³.

It is preferable that this crystallized glass includes, in terms of mol % on an oxide basis, 40-80% of SiO₂, 2-20% of Al₂O₃, 10-40% of Li₂O, and 0.1-3% of SnO₂.

### Advantageous Effect of the Invention

The present invention provides a crystallized glass having a low bubble density and excellent visible-light transmittance.

### DESCRIPTION OF EMBODIMENTS

In this specification, the term “amorphous glass” means a glass which, when analyzed by the X-ray powder diffractometry which will be described later, shows no diffraction peak indicating a crystal. A “crystallized glass” is a glass obtained by heat-treating an “amorphous glass” to precipitate crystals therein and hence includes the crystals. In this specification, an “amorphous glass” and a “crystallized glass” are sometimes inclusively referred to as a “glass”. There are cases where an amorphous glass which is to be converted to a crystallized glass by a heat treatment is called a “base glass for crystallized glass”.

In this specification, the term “visible-light transmittance” means an average transmittance for light having wavelengths ranging from 380 nm to 780 nm. “Haze” is measured using an illuminant C in accordance with JIS K3761:2000.

In this specification, an examination by X-ray powder diffractometry is performed for 2θ in the range of 10°-80° using a CuKα ray. In the case where a diffraction peak has appeared, the precipitated crystals are identified by the Hanawalt method. Of the crystals identified by this method, crystals identified from peak group including a peak highest in integrated intensity are regarded as main crystals.

Hereinafter, the term “chemically strengthened glass” means a glass which has undergone a chemical strengthening treatment, and “glass for chemical strengthening” means a glass which has not undergone any chemical strengthening treatment.

In this specification, glass compositions are expressed in terms of mol % on an oxide basis unless otherwise indicated, and mol % is often abbreviated simply to “%”. Furthermore, the term “-” indicating a numerical range is used in the meaning of including the numerical values set forth before and after the “-” as a lower limit value and an upper limit value unless otherwise indicated.

### <Crystallized Glass>

The present crystallized glass typically has a plate shape, and may have a flat shape or a curved shape.

In the case where the present crystallized glass has a plate shape, the thickness (t) thereof is preferably 3 mm or less, and is more preferably, hereinafter stepwisely, 2 mm or less, 1.6 mm or less, 1.1 mm or less, 0.9 mm or less, 0.8 mm or less, and 0.7 mm or less. From the standpoint of obtaining sufficient strength by a chemical strengthening treatment, the thickness (t) thereof is preferably 0.3 mm or more, more preferably 0.4 mm or more, still more preferably 0.5 mm or more. The present crystallized glass may include portions differing in thickness. In the case of using the present crystallized glass in portable devices such as smartphones, the thickness (t) thereof is especially preferably 0.4 mm-0.8 mm from the standpoint of weight and strength.

Since the present crystallized glass has a high visible-light transmittance in terms of transmittance in a thickness of 0.7 mm, the crystallized glass, when used as the cover glass of portable displays, renders images on the display screens easy to see. The visible-light transmittance thereof is preferably 88% or more, more preferably 90% or more. The higher the visible-light transmittance, the more the crystallized glass is preferred. However, the visible-light transmittance of a crystallized glass is usually 93% or less, typically 92% or less.

In the case of a crystallized glass not having an actual thickness of 0.7 mm, the light transmittance thereof in terms of transmittance in a thickness of 0.7 mm can be calculated from a measured value in accordance with Lambert-Beer's law. In the case where the thickness t is more than 0.7 mm, the thickness may be adjusted to 0.7 mm by polishing, etching, etc. for the measurement.

The transmission haze of the present crystallized glass, in terms of haze in a thickness of 0.7 mm, may be 1.0% or less, and is preferably 0.4% or less, more preferably 0.3% or less, still more preferably 0.2% or less, especially preferably 0.15% or less. Smaller values of haze are preferred, but reducing the volume fraction of crystalline phase or the crystal-grain diameter to reduce the haze results in a decrease in mechanical strength. From the standpoint of increasing the mechanical strength of the present crystallized glass, the haze in a thickness of 0.7 mm is preferably 0.02% or more, more preferably 0.03% or more.

The present crystallized glass has Y value in the XYZ color system of preferably 87 or more, more preferably 88 or more, still more preferably 89 or more, especially preferably 90 or more. In the case of using the present crystallized glass as cover glass for portable displays, it is preferable that the coloration of the glass itself is as little as possible, from the standpoint of increasing reproducibility of the displayed-color in the case of using the crystallized glass on the display screen side or from the standpoint of maintaining design attractiveness in the case of using the crystallized glass on the housing side. The present crystallized glass hence has an excitation purity Pe of preferably 1.0 or less, more preferably 0.75 or less, still more preferably 0.5 or less, especially preferably 0.35 or less, most preferably 0.25 or less.

One aspect of the present crystallized glass has a volume fraction of crystalline phase of 30% or more and hence is harder and less apt to crack as compared with glasses which has not been crystallized.

The volume fraction of crystalline phase is determined by the Rietveld method. From the standpoint of increasing the strength, the volume fraction of crystalline phase of the present crystallized glass is more preferably 50% or more, still more preferably 60% or more, yet still more preferably 70% or more. There are cases where too high a volume fraction of crystalline phase is prone to result in a decrease in transmittance. From the standpoint of ensuring transparency, the volume fraction of crystalline phase thereof is preferably 90% or less, more preferably 85% or less. In the case where transparency is especially important, the volume fraction of crystalline phase thereof is preferably 60% or less.

In the present crystallized glass, the number of bubbles having a major-axis length of 10 μm-50 μm is 3 or less, preferably 1 or less, per 10 cm³. The term “major-axis length” herein means the distance between two points in the bubble which are most apart from each other among any combinations of two points therein. In the case where a bubble having a major-axis length exceeding 50 μm is present in a crystallized glass, this results in an appearance failure. It is hence preferable that a bubble having a major-axis length exceeding 50 μm is not present. Even if such a bubble is present, the number thereof is preferably 1 or less per 10 cm³.

In the case where bubbles are present in a base glass which has not undergone crystallization, the crystallized glass obtained therefrom by crystallization also contains bubbles. Since one aspect of the crystallized glass of the present invention has a volume fraction of crystalline phase of 30% or more, if a large number of bubbles are present in a base glass of the crystallized glass, the crystallized glass has a shortened distance between bubble and crystal and thus the visible-light transmittance and color are prone to be deteriorated. Furthermore, formation of crystal around the bubbles is prone to result in an appearance failure, e.g., flickering.

In addition, the presence of bubbles in the base glass promotes nucleation in a crystallization step. For example, an investigation made by the present inventors has revealed that in the case of a crystallized glass including two kinds of crystals, crystals precipitating at higher temperatures (e.g., lithium disilicate crystals) may be selectively formed around the bubbles to impair the transparency. Because of this, the number of bubbles is especially important for crystallized glasses having a high volume fraction of crystalline phase of 30% or above.

It is preferable that the present crystallized glass is a lithium aluminosilicate glass including 40-80% of SiO₂, 2-20% of Al₂O₃, and 10-40% of Li₂O.

The present crystallized glass more preferably includes 60-75% of SiO₂, 3-6% of Al₂O₃, and 15-25% of Li₂O.

It is preferable that the present crystallized glass includes LAS crystals. The term “LAS crystals” in this specification means crystals including SiO₂, Al₂O₃, and Li₂O. Crystallized glasses including LAS crystals have excellent chemical strengthening property.

The LAS crystals preferably include crystals of at least one kind selected from the group consisting of β-spodumene crystals, petalite crystals, and eucryptite crystals. These crystals may have crystal structures different from the typical crystal structures. Namely, the crystallized glass may have a distorted crystal structure. The same applies in the other crystals which will be described later.

It is preferable that the present crystallized glass includes two or more kinds of crystals, and may include crystals other than LAS crystals. This is because in cases when crystals of two or more kinds are included, each crystal is apt to have a reduced size. The smaller sizes of the crystals included in the crystallized glass improve the transparency.

When the present crystallized glass includes no LAS crystals, it is preferable that the present crystallized glass includes lithium silicate crystals. Crystallized glasses including lithium silicate crystals have relatively excellent chemical strengthening property. In this case, the lithium silicate crystals preferably are lithium metasilicate crystals. Examples of crystals other than LAS crystals include lithium metasilicate, lithium disilicate, and lithium phosphate. The lithium phosphate may include Si.

One aspect of the present crystallized glass is characterized by including SnO₂. SnO₂ is known to serve as a refining agent in a glass production step. In the case of the present crystallized glass including SnO₂, in a step of producing the amorphous glass which had not undergone crystallization, bubbles contained in the glass are small and the number thereof is small.

It is preferable to include SnO₂ in an amount of 0.1-3.0%. In the case where SnO₂ was used as a refining agent, since the crystallized glass may have a color, it is preferable that the content of SnO₂ does not exceed 3.0%. The content of SnO₂ is preferably 2.0% or less, more preferably 1.0% or less. The content of SnO₂ is preferably 0.15% or more.

In the present crystallized glass, SiO₂ is a component which constitutes a glass network, is a structural component of LAS crystals, and is essential.

From the standpoint of facilitating the formation of LAS crystals, the content of SiO₂ may be 40% or more, and is preferably 55% or more, more preferably 60% or more, still more preferably 65% or more. From the standpoint of enhancing the meltability of the glass, the content of SiO₂ may be 80% or less, and is preferably 77% or less, more preferably 75% or less.

Al₂O₃ is a structural component of LAS crystals and is a component which improves the ion exchange property in chemical strengthening to enhance the surface compressive stress after the strengthening.

From the standpoint of the chemical strengthening characteristics, the content of Al₂O₃ may be 2% or more, and is preferably 3% or more, more preferably 4% or more. From the standpoint of enhancing the meltability of the glass, the content of Al₂O₃ may be 20% or less, and is preferably 15% or less, more preferably 10% or less, still more preferably 7% or less, yet still more preferably 6% or less.

Li₂O is a component forming compressive stress near the surfaces by ion exchange and is a structural component of LAS crystals. From the standpoint of increasing the compressive stress, the content of Li₂O may be 10% or more, and is preferably 15% or more, more preferably 18% or more, still more preferably 20% or more. From the standpoint of the chemical durability of the glass, the content of Li₂O may be 40% or less, and is preferably 35% or less, more preferably 30% or less, still more preferably 25% or less.

Na₂O is a component forming compressive stress by ion exchange, and there are cases where inclusion thereof in a small amount enhances the stability of the glass. In the case where Na₂O is contained, the content thereof is preferably 0.1% or more, more preferably 0.5% or more, still more preferably 1.0% or more. From the standpoint of maintaining the chemical durability, the content of Na₂O is preferably 10% or less, more preferably 8% or less, still more preferably 6% or less.

K₂O is an optional component and may be contained. From the standpoint of maintaining the chemical durability, the content of K₂O is preferably 3% or less, more preferably 2% or less, still more preferably 1% or less.

MgO, CaO, SrO, and BaO are each a component which enhances the meltability of the glass but has a tendency to reduce the ion exchange property. The total content MgO+CaO+SrO+BaO of them is preferably 5% or less, more preferably 3% or less, still more preferably 1% or less.

P₂O₅ is a component which accelerates crystallization, and is preferably contained in an amount of 0.2% or more. From the standpoint of facilitating the crystallization, the content of P₂O₅ is more preferably 0.4% or more, still more preferably 0.6% or more. In the case where the content of P₂O₅ is too high, not only phase separation is prone to occur during melting but also the acid resistance considerably decreases. Consequently, the content thereof is preferably 4% or less, more preferably 2% or less.

ZrO₂ is a component which increases the surface compressive stress to be produced by ion exchange. The content of ZrO₂ is preferably 0.5% or more, more preferably 1% or more. From the standpoint of suppressing devitrification during melting, the content thereof is preferably 5% or less, more preferably 3% or less.

The present crystallized glass may contain B₂O₃. From the standpoints of improving the chipping resistance and improving the meltability, the content of B₂O₃ is preferably 0.1% or more, more preferably 0.2% or more. In the case where the content of B₂O₃ is too high, striae and phase separation are prone to occur during melting to give a glass for chemical strengthening having reduced quality. Consequently, the content of B₂O₃ is preferably 5% or less, more preferably 3% or less, still more preferably 1% or less.

When a base glass for the present crystallized glass contains an Fe component, there is a concern that the Fe component might be reduced in a crystallization step to cause a coloration, resulting in a decrease in visible-light transmittance. The content of an Fe component hence is preferably 200 ppm or less. In this specification, the content of Fe is expressed in terms of proportion by mass.

The present crystallized glass has a Young's modulus of preferably 80 GPa or more, more preferably 85 GPa or more, still more preferably 90 GPa or more, especially preferably 95 GPa or more, from the standpoint of suppressing the glass from warping during a chemical strengthening treatment. There are cases where the present crystallized glass is polished before use. From the standpoint of the polishing characteristics, the Young's modulus thereof is preferably 130 GPa or less, more preferably 120 GPa or less, still more preferably 110 GPa or less.

The present crystallized glass has a high Vickers hardness and is less apt to receive scratches. The Vickers hardness of the present crystallized glass is preferably 680 GPa or more, more preferably 720 GPa or more, still more preferably 750 GPa or more.

The present crystallized glass has a high fracture toughness and is less apt to be fractured in a violent manner even when high compressive stress is formed therein by chemical strengthening. The fracture toughness can be measured, for example, by a DCDC method (Acta metall. mater, Vol. 43, p. 3453-3458, 1995). The fracture toughness of the present crystallized glass is preferably 0.85 MPa·m^{1/2} or more, more preferably 0.90 MPa·m^{1/2} or more, still more preferably 1.0 MPa·m^{1/2} or more. When the fracture toughness value is in the above range, it is possible to obtain a glass having high fracture resistance. There is no particular upper limit on the fracture toughness of the present crystallized glass. However, the fracture toughness thereof is typically 2.0 MPa·m^{1/2} or less.

<Method of producing Crystallized Glass and Chemically Strengthened Glass>

The present crystallized glass can be produced by a method in which an amorphous glass is heat-treated and crystallized. Chemically strengthened glass can be produced by subjecting the present crystallized glass to an ion-exchange treatment.

### (Production of Amorphous Glass)

An amorphous glass of the present invention can be produced, for example, by the following method. The production method shown below is an example of producing a plate-shaped glass.

Raw materials for glass are mixed together so that a glass having a preferred composition is obtained therefrom, and the mixture is heated and melted in a glass melting furnace. Thereafter, the molten glass is homogenized by bubbling, stirring, addition of a refining agent, etc., and the homogenized glass is formed into a glass plate having a given thickness by a known forming method and then annealed. Alternatively, use may be made of a method in which the molten glass is formed into a block, annealed, and then cut into a plate shape.

### (Crystallization Treatment)

The amorphous glass obtained by the procedure shown above is heat-treated, thereby obtaining a crystallized glass.

The heat treatment may be a two-step heat treatment in which the glass is heated from room temperature to a first treatment temperature, held at that temperature for a certain time period, and then held at a second treatment temperature which is higher than the first treatment temperature for a certain time period. Three-step heat treatment in which the glass is further held at a third treatment temperature for a certain time period after the two-step heat treatment may be performed. Alternatively, the heat treatment may be a one-step heat treatment in which the glass is held at a specific treatment temperature and then cooled to room temperature.

In the case of employing the two-step heat treatment, the first treatment temperature is preferably in a temperature range where the glass composition has a high nucleation rate, and the second treatment temperature is preferably in a temperature range where the glass composition has a high crystal growth rate. In the case of employing the three-step heat treatment, it is preferable that the first treatment temperature and the second treatment temperature are temperatures at which the glass has a high nucleation rate and that the third treatment temperature is a temperature at which the glass has a high crystal growth rate. Alternatively, the first treatment temperature may be a temperature at which the glass has a high nucleation rate, and the second treatment temperature and the third treatment temperature may be temperatures at which the glass has a high crystal growth rate.

It is preferable that the period of holding the glass at the first treatment temperature is long so that a sufficiently large number of crystal nuclei are formed. By forming a large number of crystal nuclei, a size of each crystal becomes small, and thereby a highly transparent crystallized glass can be obtained.

Examples of the two-step treatment include a treatment in which the glass is held at a first treatment temperature of, for example, 500-700° C. for 1-6 hours and then held at a second treatment temperature of, for example, 600-800° C. for 1-6 hours.

Examples of the three-step treatment include a treatment in which the glass is held at a first treatment temperature of, for example, 500-600° C. for 1-6 hours, subsequently held at a second treatment temperature of, for example, 550-650° C. for 1-6 hours, and then held at a third treatment temperature of, for example, 600-800° C. for 1-6 hours. Examples of the one-step treatment include a treatment in which the glass is held at a temperature of, for example, 500-800° C. for 1-6 hours.

The crystallized glass obtained by the procedure described above is ground and polished according to need to form a crystallized-glass plate. In cases when the crystallized-glass plate is to be cut into a given shape and size or chamfered, it is preferred to conduct the cutting or chamfering before the crystallized-glass plate is subjected to a chemical strengthening treatment. This is because a compressive-stress layer is formed also in the end surfaces by the subsequent chemical strengthening treatment.

The present crystallized glass can be chemically strengthened.

### (Chemical Strengthening Treatment)

A chemical strengthening treatment is a treatment in which a glass is brought into contact with a metal salt by a method such as immersing the glass in a melt of the metal salt (e.g., potassium nitrate) including a metal ion having a large ionic radius (typically an Na ion or a K ion), thereby replacing metal ions having a small ionic radius (typically Na ions or Li ions) contained in the glass with the metal ions having a large ionic radius (typically, Na ions or K ions for replacing Li ions, K ions for replacing Na ions).

From the standpoint of increasing the rate of the chemical strengthening treatment, it is preferred to utilize “Li—Na exchange”, in which Li ions in the glass are replaced with Na ions. From the standpoint of forming high compressive stress by ion exchange, it is preferred to utilize “Na—K exchange”, in which Na ions in the glass are replaced with K ions.

Examples of the molten salt for conducting the chemical strengthening treatment include nitrates, sulfates, carbonates, and chlorides. Among these, examples of the nitrates include lithium nitrate, sodium nitrate, potassium nitrate, cesium nitrate, and silver nitrate. Examples of the sulfates include lithium sulfate, sodium sulfate, potassium sulfate, cesium sulfate, and silver sulfate. Examples of the carbonates include lithium carbonate, sodium carbonate, and potassium carbonate. Examples of the chlorides include lithium chloride, sodium chloride, potassium chloride, cesium chloride, and silver chloride. Any one of these molten salts may be used alone, or two or more thereof may be used in combination.

For treatment conditions for the chemical strengthening treatment, time period, temperature, etc. can be selected while taking account of the glass composition, the kind of the molten salt, etc. For example, the present crystallized glass is subjected to a chemical strengthening treatment at a temperature of preferably 600° C. or less, more preferably 500° C. or less, for preferably 20 hours or less.

The chemically strengthened glass obtained by chemically strengthening the present crystallized glass is useful as a cover glass for use in electronic appliances such as mobile appliances, e.g., portable telephones and smartphones. The chemically strengthened glass is useful also as a cover glass of electronic appliances not intended to be carried, such as TVs, personal computers, and touch panels, and as wall surfaces of elevators or wall surfaces (whole surface displays) of architecture such as houses and buildings. Furthermore, the chemically strengthened glass is useful as building materials such as window glasses, table tops, interior materials for motor vehicles, airplanes, etc., and cover glasses for these, and as housings having a curved shape, etc.

### Examples

The present invention is explained below by reference to the following Examples, but the invention is not limited by the Examples. Examples 1, 2, 7, and 11 are Examples according to one aspect of the present invention. Examples 3, 8, and 12 are Examples according to another aspect of the present invention.

### <Preparation of Amorphous Glass and Crystallized Glass>

Raw materials for glass were mixed together so as to result in each of the glass compositions shown in the section “Composition” in Tables 1 and 2 in terms of mol % on an oxide basis, so that each glass was obtained in an amount of 400 g. Subsequently, each mixture of raw materials for glass was placed in a platinum crucible, introduced into a 1,600° C. electric furnace, and then melted for about 3 hours to be defoamed and homogenized.

The glass obtained was poured into a mold, held at 475° C. for 1 hour, and then cooled to room temperature at a rate of 0.5° C./min to obtain a glass block.

The glass blocks were each heat-treated under the conditions shown in the section “Crystallization conditions” in Tables 1 and 2 to obtain a crystallized-glass block. The sets of conditions shown in the section “Crystallization conditions” have the following meaning: in cases when, for example, a set of conditions consists of “540° C. 4 h” in the upper cell, “600° C. 4 h” in the middle cell, and “700° C. 4 h” in the lower cell, this means that the glass block was heated from room temperature to 540° C. and held for 4 hours, subsequently heated to 600° C. and held for 4 hours, further heated to 700° C. and held for 4 hours, and then cooled to room temperature.

The crystallized-glass blocks obtained were cut, ground, and polished to obtain crystallized-glass plates having dimensions of 30×30×0.7 mm.

### <Evaluation>

The crystallized-glass plates obtained were visually examined for presence or absence of appearance failure such as inclusions, flickering, etc. The number of bubbles having a major-axis length of 10 μm-50 μm was counted using a microscope.

Furthermore, using a spectrophotometer (LAMBDA 950, manufactured by PerkinElmer, Inc.) equipped with an integrating-sphere unit (150 mm InGaAs Int. Sphere) as a detector, the visible-light transmittance of each crystallized-glass plate was measured while bringing the crystallized-glass plate into contact with the integrating sphere.

Moreover, a part of the crystallized glass was pulverized, whereby the precipitated crystals were identified by X-ray powder diffractometry, and the volume fraction of crystalline phase was estimated by the Rietveld method. The kinds of the crystals are shown in the section “Kinds of crystals” in Tables 1 and 2, in which PE indicates petalite crystals, LD indicates lithium disilicate crystals, SP indicates β-spodumene crystals, LS indicates lithium metasilicate crystals, and LP indicates lithium phosphate crystals. In the case where plural kinds of crystals are shown, the crystals shown in upper section are main crystals.

### (Conditions for X-Ray Diffractometry Measurement)

Measurement Apparatus: Smart Lab, manufactured by Rigaku Corp.

X ray used: CuKα ray

Measurement range: 2θ=10°-80°

Speed: 1°/min

Step: 0.01°

TABLE 1

| | | Example 1 | Example 2 | Example 3 | Example 4 | Example 5 | Example 6 |
|---|---|---|---|---|---|---|---|
| Composition | SiO₂ | 70.8 | 70.8 | 70.8 | 70.9 | 70.9 | 70.9 |
| (mol %) | Al₂O₃ | 4.4 | 4.4 | 4.4 | 4.4 | 4.4 | 4.4 |
| | Li₂O | 20.8 | 20.8 | 20.8 | 20.8 | 20.8 | 20.8 |
| | Na₂O | 1.6 | 1.6 | 1.6 | 1.6 | 1.6 | 1.6 |
| | K₂O | | | | | | |
| | MgO | | | | | | |
| | ZrO₂ | 1.5 | 1.5 | 1.5 | 1.5 | 1.5 | 1.5 |
| | B₂O₃ | 0.2 | 0.2 | 0.2 | 0.2 | 0.2 | 0.2 |
| | P₂O₅ | 0.6 | 0.6 | 0.6 | 0.6 | 0.6 | 0.6 |
| | CaO | | | | | | |
| | SrO | | | | | | |
| | SnO₂ | 0.1 | 0.1 | 0.1 | | | |

| | | | | | | |
|---|---|---|---|---|---|---|
| Crystallization conditions | 540° C. 4 h | 540° C. 4 h | 540° C. 4 h | 540° C. 4 h | 540° C. 4 h | 540° C. 4 h |
| | 600° C. 4 h | 600° C. 4 h | 600° C. 4 h | 600° C. 4 h | 600° C. 4 h | 600° C. 4 h |
| | 700° C. 4 h | 700° C. 8 h | 650° C. 2 h | 700° C. 4 h | 700° C. 8 h | 650° C. 2 h |
| Kinds of crystals | PE | PE | PE | PE | PE | PE |
| | LD | LD | LD | LD | LD | LD |
| Volume fraction of crystalline | 55.2% | 84.2% | 24.4% | 54.6% | 78.7% | 27.0% |
| phase (average) | | | | | | |
| (Number of samples with | 0/3 | 0/3 | 0/1 | 3/5 | 5/5 | 1/5 |
| appearance failure)/(total number) | | | | | | |
| Number of bubbles per 10 cm³ | 1.7 | 1.3 | 0.0 | 23.2 | 25.8 | 13.8 |
| (average) | | | | | | |
| Visible-light transmittance (%) | 88.5 | 88.2 | 90.8 | 89.1 | 87.8 | 90.8 |

TABLE 2

| | | Example 7 | Example 8 | Example 9 | Example 10 | Example 11 | Example 12 |
|---|---|---|---|---|---|---|---|
| Composition | SiO₂ | 69.7 | 69.7 | 69.8 | 69.8 | 63.0 | 63.0 |
| (mol %) | Al₂O₃ | 5.3 | 5.3 | 5.3 | 5.3 | 22.3 | 22.3 |
| | Li₂O | 21.3 | 21.3 | 21.3 | 21.3 | 4.2 | 4.2 |
| | Na₂O | | | | | 2.0 | 2.0 |
| | K₂O | 1.0 | 1.0 | 1.0 | 1.0 | | |
| | MgO | | | | | | |
| | ZrO₂ | 1.7 | 1.7 | 1.7 | 1.7 | 2.3 | 2.3 |
| | B₂O₃ | 0.2 | 0.2 | 0.2 | 0.2 | | |
| | P₂O₅ | 0.8 | 0.8 | 0.8 | 0.8 | 3.0 | 3.0 |
| | CaO | | | | | | |
| | SrO | | | | | 1.0 | 1.0 |
| | SnO₂ | 0.1 | 0.1 | | | 2.1 | 2.1 |

| | | | | | | | | |
|---|---|---|---|---|---|---|---|---|
| Crystallization conditions | 540° C. 4 h | 540° | C. 4 h | 540° C. 4 h | 540° | C. 4 h | 750° C. 4 h | 650° C. 4 h |
| | 600° C. 4 h | 600° | C. 4 h | 600° C. 4 h | 600° | C. 4 h | 900° C. 4 h | 850° C. 3 h |
| | 700° C. 2 h | 700° | C. 0.5 h | 700° C. 2 h | 700° | C. 0.5 h | | |

| | | | | | | |
|---|---|---|---|---|---|---|
| Kinds of crystals | PE | PE | PE | PE | SP | SP |
| | LD | LD | LD | LD | | |
| Volume fraction of crystalline | 63.1% | 28.4% | 63.0% | 27.0% | 31.5% | 23.6% |
| phase (average) | | | | | | |
| (Number of samples with | 0/1 | 0/1 | 2/4 | 0/5 | 0/3 | 0/2 |
| appearance failure)/(total number) | | | | | | |
| Number of bubbles per 10 cm³ | 3.0 | 1.0 | 13.8 | 20.4 | 0.7 | 0 |
| (average) | | | | | | |
| Visible-light transmittance (%) | 89.1 | 89.0 | 86.7 | 89.8 | 90.5 | 91.2 |

Comparisons between Example 1 and Example 4, Example 2 and Example 5, Example 3 and Example 6, Example 7 and Example 9, and Example 8 and Example 10 reveal that the Examples containing SnO₂ had fewer bubbles than the Examples obtained by crystallizing the glass having approximately same composition except for not containing SnO₂ under the same conditions.

Furthermore, comparisons between Example 1 and Example 4, Example 2 and Example 5, and Example 7 and Example 9 reveal that the Examples having fewer bubbles were lower in the proportion of samples with an appearance failure. However, comparisons between Example 3 and Example 6 and Example 8 and Example 10 reveal that Examples 6 and 10 having a large number of bubbles were low in the proportion of samples with an appearance failure. It can hence be seen that in the case of high volume fraction of crystalline phase, an appearance failure can be inhibited by reducing the number of bubbles.

While the present invention has been described in detail and with reference to specific embodiments thereof, it will be apparent to one skilled in the art that various changes and modifications can be made therein without departing from the spirit and scope thereof. This application is based on a Japanese patent application filed on Sep. 25, 2020 (Patent Application No. 2020-161095), the contents thereof being incorporated herein by reference.

What is claimed is:

1. A crystallized glass having a visible-light transmittance of 88% or more in terms of a thickness of 0.7 mm,
having a volume fraction of a crystalline phase of 30% or more, and
comprising SnO₂,
wherein the number of bubbles having a major-axis length of 10 μm-50 μm is 3 or less per 10 cm³.

2. The crystallized glass according to claim 1, comprising, in terms of mol % on an oxide basis:
40-80% of SiO₂;
2-20% of Al₂O₃;
10-40% of Li₂O; and
0.1-3% of SnO₂.

3. The crystallized glass according to claim 1, comprising LAS crystals.

4. The crystallized glass according to claim 3, wherein the LAS crystals include crystals of at least one kind selected from the group consisting of β-spodumene crystals, petalite crystals, and eucryptite crystals.

5. The crystallized glass according to claim 1, further comprising crystals of at least one kind selected from the group consisting of lithium metasilicate crystals, lithium disilicate crystals, and lithium phosphate crystals.

6. The crystallized glass according to claim 1, wherein the number of bubbles having a major-axis length of 10 μm-50 μm is 1 or less per 10 cm³.

7. The crystallized glass according to claim 1, wherein the number of bubbles having a major-axis length exceeding 50 μm is 1 or less per 10 cm³.

8. The crystallized glass according to claim 7, wherein the number of bubbles having a major-axis length exceeding 50 μm is zero per 10 cm³.

9. The crystallized glass according to claim 1, having a thickness of 0.4 mm-0.8 mm.

10. The crystallized glass according to claim 1, wherein the volume fraction of a crystalline phase is 50%-90%.

11. The crystallized glass according to claim 1, wherein the volume fraction of a crystalline phase is 60%-85%.

12. The crystallized glass according to claim 1, having an Fe component in an amount of 200 ppm or less.

13. The crystallized glass according to claim 1, comprising, in terms of mol % on an oxide basis:
60-75% of SiO₂;
3-6% of Al₂O₃;
15-25% of Li₂O; and
0.15-1% of SnO₂.

14. A crystallized glass comprising crystals of at least one kind selected from the group consisting of β-spodumene crystals, petalite crystals, and eucryptite crystals, and
having a visible-light transmittance of 88% or more in terms of a thickness of 0.7 mm,
wherein the number of bubbles having a major-axis length of 10 μm-50 μm is 3 or less per 10 cm³.

15. The crystallized glass according to claim 14, comprising, in terms of mol % on an oxide basis:
40-80% of SiO₂;
2-20% of Al₂O₃;
10-40% of Li₂O; and
0.1-3% of SnO₂.

16. The crystallized glass according to claim 14, wherein the number of bubbles having a major-axis length of 10 μm-50 μm is 1 or less per 10 cm³.

17. The crystallized glass according to claim 14, having a thickness of 0.4 mm-0.8 mm.

18. The crystallized glass according to claim 14, having a volume fraction of a crystalline phase of 50%-90%.

19. The crystallized glass according to claim 18, wherein the volume fraction of a crystalline phase is 60%-85%.
